(19) United States
(12) Patent Application Publication
(10) Pub. No.: US 2006/0230927 A1
(43) Pub. Date: Oct. 19, 2006

(54) Hydrogen separation

(76) Inventors: Xiaobing Xie, Lafayette, CO (US); Michael V. Mundschau, Longmont, CO (US)

Correspondence Address: CAROL WILSON;BP AMERICA INC., MAIL CODE 5 EAST, 4101 WINFIELD ROAD, WARRENVILLE, IL, 60555, US

(21) Appl. No.: 11/386,188

(22) Filed: Mar. 22, 2006

Related U.S. Application Data
(60) Provisional application No. 60/667,631, filed on Apr. 2, 2005.
(60) Provisional application No. 60/676,266, filed on Apr. 29, 2005.

(51) Int. Cl. B01D 53/22

(52) U.S. Cl. 95/55

(57) ABSTRACT

A method for separating hydrogen from a high pressure gas containing hydrogen and carbon dioxide using a vanadium/nickel alloy membrane having a palladium coating, the membrane containing from zero up to about 10 atomic percent nickel, and having a thickness of from about 75 to about 500 microns. The membrane is employed at a temperature of from about 300 to about 440° C., under a pressure of from about 250 to about 500 psia, and a hydrogen partial pressure gradient across the membrane is maintained to provide a hydrogen partial pressure on the permeate side of the membrane of from about 0.02 to about 2 psia.

### STATEMENT OF GOVERNMENT INTEREST

This invention was made with the support of the United States Department of Energy under DOE Contract No. DE-FC26-01NT41145. The Government has certain rights in the invention.

### FIELD OF THE INVENTION

This invention relates to a process and membrane combination for the extraction of molecular hydrogen (hydrogen) from a gas containing a mixture of at least hydrogen and carbon dioxide. In particular, this invention relates to the separation of hydrogen from a high pressure industrial gas product formed by the water-gas-shift (WGS) reaction. This invention also relates to an improvement in the sequestration of carbon dioxide.

### BACKGROUND OF THE INVENTION

Membranes for the separation of hydrogen from other gases are well known, “Membrane Handbook” by Zolandz et al., pages 95-98 (1992).

Such membranes include the class known as nonporous (dense) membranes that dissociate at least one hydrogen molecule into a non-molecular form such as H⁺, H⁻, or as neutral hydrogen atoms, or proton (positively charged hydrogen ion)/electron pair on one side of the membrane, transport such pair to the opposing side of the membrane, and then reassociate same to molecular hydrogen at that opposing side. This is followed by desorption of hydrogen from such opposing side to produce a relatively pure hydrogen permeate. This permeate is physically separate from the other constituents of the original gas mixture of which the hydrogen was initially a part. See U.S. Pat. Nos. 3,350,844 and 3,350,846. Such membranes and their operation are particularly well described in US Patent Application Publication US 2003/0183080 A1. The purified hydrogen permeate has a number of industrial uses, particularly in the petroleum and chemical industries, as well as other end uses such as the operation of fuel cells and turbine engines, U.S. Pat. No. 4,810,485.

In general hydrogen extraction membranes are characterized as organic and inorganic, the inorganic class being further characterized as ceramic or metallic. Polymeric membranes are representative of the organic class, and, in general, are not highly selective for hydrogen over other gaseous entities. Porous membranes (those which transport molecular hydrogen) also evidence low hydrogen selectivity relative to other gases. Nonporous or dense membranes (those that transport protons as opposed to molecular hydrogen) which are ceramic, in general, can have a low permeability to protons depending upon temperature. Nonporous (dense) metallic membranes, and porous ceramic membranes coated on one or both sides with a nonporous (dense) metal layer are highly selective to hydrogen and transport hydrogen atoms (as opposed to protons), hence their appeal as a means for the separation of hydrogen as a relatively pure product stream.

The separation of hydrogen from various gas mixtures, including industrial gas mixtures, is known. Examples of industrial gas mixtures are the products of carbonaceous material gasification, steam/methane reforming, and the water-gas-shift reaction. U.S. Pat. No. 4,810,485 integrates a hydrogen production process such as the water-gas-shift reaction with a nonporous metallic, e.g., nickel or vanadium, hydrogen separation membrane. This patent teaches that by the continued withdrawal of hydrogen from its site of production, the chemical equilibrium of the hydrogen formation reaction will be continually shifted to the right thereby favoring greater hydrogen production. U.S. Pat. No. 5,217,506 similarly employs vanadium based membranes with WGS reaction products.

Dissociated hydrogen permeable vanadium membranes alloyed with 1 to 20 atomic percent (%) nickel are known, U.S. Pat. No. 6,395,405 and Nishimura et al, “Hydrogen Permeation Characteristics of Vanadium-Nickel Alloys”, Materials Transactions JIM, Volume 32, No. 5, May 1991, The Japan Institute of Metals.

Vanadium membranes coated on one or both sides with palladium to assist in hydrogen dissociation at the hydrogen input (feed source side), and reassociation and desorption at the hydrogen permeate side (sink side) are known, U.S. Pat. Nos. 3,350,844 and 5,149,420.

Hydrogen embrittlement (embrittlement) of metals such as vanadium is a known metallurgical phenomenon, as is the use of vanadium alloyed with various metals such as nickel, chromium and titanium to render the membrane more resistant to such embrittlement, U.S. Pat. No. 5,215,729 and Nishimura et al cited above.

Although alloying a dense metallic membrane such as vanadium with other metals can lower the probability of hydrogen embrittlement of the membrane, it can also lower the proton flux through the membrane from the hydrogen supply side to the sink side of the membrane.

In accordance with this invention, a process has been found that, in combination with certain nonporous (dense) membranes, exhibits surprisingly high proton flux rates as well as physical stability under substantially elevated pressures.

### SUMMARY OF THE INVENTION

Pursuant to this invention, a method is provided for separating hydrogen from a reaction product using a dense vanadium based membrane wherein the membrane can contain from zero up to about 10 atomic percent (atom %) nickel. The membrane employed in the process of this invention has a palladium coating on at least its hydrogen source side and has a thickness of from about 75 to about 500 microns. The membrane is exposed on its source side to at least one gaseous reaction product at a temperature of from about 300 to about 440 degrees Centigrade (° C.), and a pressure of from about 250 to about 500 psia. A hydrogen partial pressure gradient across the membrane is maintained such that from the source side pressure of about 250 to 500 psia the hydrogen partial pressure on the permeate side is from about 0.02 to about 2 psia.

The process of this invention provides a high dissociated hydrogen flux rate through the membrane without physical failure of the membrane due to the high hydrogen partial pressure differential maintained across it. Ideally this invention allows for the elimination of low-temperature WGS reactors and pressure swing adsorption steps now used in the production and purification of hydrogen.

### DETAILED DESCRIPTION OF THE INVENTION

A number of commercial processes produce a gaseous reaction product that contains at least carbon dioxide and hydrogen at an elevated pressure. Such processes include a variety of hydrocarbon reformation operations, carbonaceous material (coal, peat, shale and the like) gasification and WGS processes. Although this invention, for sake of clarity and brevity, will be described here in after in respect of the WGS reaction, this invention is not so limited.

Conversion of carbonaceous materials into mixtures of hydrogen and carbon monoxide (synthesis gas) followed by the WGS reaction is well established technology, and currently used commercially to produce millions of tons of hydrogen annually. The WGS reaction is exothermic, and production of hydrogen there from is known to be favored at lower temperatures. WGS reactors typically use catalyst precursors containing 90-95 weight percent (wt. %) ferrous oxide and 5-10 wt. % chromium trioxide. Reactor inlet temperatures vary depending on the catalyst and the condition thereof, but are generally from about 300 to about 400° C., and the exothermic reaction produces WGS product gases at a temperature of from about 375 to about 440° C. at a pressure of from about 250 to about 500 psia.

Suitable feed gases for the process of this invention, including, but not limited to WGS products, comprise a major (at least about 50 wt. % based on the total weight of the feed gas) of a mixture of steam, carbon dioxide, carbon monoxide, and hydrogen, with the remainder being essentially nitrogen, hydrogen sulfide, ammonia, and the like. Such feed gases can also consist essentially of at least about 50 wt. % of a mixture of hydrogen and carbon dioxide based on the total moles in the feed gas with the molar ratio of hydrogen to carbon dioxide being about 2/1.

Carbon dioxide sequestration is important in modern geopolitics and, therefore, in the global economy. If carbon dioxide is to be sequestered, for example, in deep geologic storage sites, both onshore and offshore, it will need to be compressed to overcome opposing pressures in such sites, and compression of vast quantities of carbon dioxide is expensive.

Thus, the sequestration of carbon dioxide recovered at atmospheric pressure can incur a costly penalty in meeting the pressure required by the sequestration site.

Hydrogen extraction membranes have not here to fore been known to stand up physically to high pressures for extended time periods. For example, hydrogen embrittlement of vanadium and other metal membranes leading to cracking and other physical failure of the membrane is known.

However, the high cost of compressing carbon dioxide for sequestration purposes can be avoided if dissociated hydrogen transport membranes combined with a process of using them was available which could extract hydrogen downstream from WGS or other reactors that routinely produce a gaseous product at an elevated pressure, particularly if that process operated at a high hydrogen flux rate with good physical stability of the membrane throughout the process. This invention provides just such a unique combination of process and membrane.

The process of this invention, and the membranes employed therein use and withstand, respectively, a differential pressure gradient across the membrane from its hydrogen source side to its hydrogen permeate side of from about 249 to about 499 psia, and do so while operating at a high dissociated hydrogen flux rate through the membrane of at least about 150 mL min⁻¹cm⁻², all flux rates set forth here in after having the same units.

The process/membrane combination of this invention not only accommodates substantial operating pressure differentials, but also produces essentially only the hydrogen gas into the permeate (which may be combined with sweep gas) while retaining the carbon dioxide of the original feed gas in a carbon dioxide enriched retentate that is at very substantially elevated pressures. Thus, a major advantage of this invention is that it enables carbon dioxide sequestration at the normally elevated pressures of, for example, a WGS reactor, thereby avoiding additional compression costs aforesaid. Another advantage is that by retaining carbon dioxide at elevated pressures on the source side of the membrane, the gas volume will be considerably smaller than at atmospheric pressure, which translates into reduced capital and operating costs for the transport to and injection into disposal wells or other underground storage reservoirs. Further, taxation of carbon dioxide emissions is becoming a driving force for carbon dioxide sequestration. This invention allows an operator the opportunity to conduct a sequestration system that operates below the rate of the applicable carbon tax, and, therefore, is of substantial benefit to industries that generate large amounts of carbon dioxide.

In use, a WGS feed gas mixture containing hydrogen and other gaseous entities such as carbon dioxide, is impressed on one side of the membrane (hydrogen source side). This feed gas is normally introduced at a first end of the membrane (inlet end). The feed gas then sweeps across the surface of the source side of the membrane toward an outlet end. With a nonporous (dense) membrane, hydrogen dissociates on the source side into a non-molecular form such as H⁺, H⁻, or as neutral hydrogen atoms or proton/electron pairs, which form is then transported across the full thickness of the membrane to its opposing side (hydrogen sink side). At the sink (permeate) side, this form of dissociated hydrogen is re-associated to form hydrogen which then undergoes desorption and removal as a purified hydrogen permeate stream.

The feed gas first physically impinges on the source side at the inlet end of the membrane as aforesaid, remains in physical contact with the source side as it sweeps across the membrane, and disengages physically from that side at or near the opposing outlet end. During its travel along the source side of the membrane, the feed gas gives up hydrogen to the dissociation mechanism, and, hence, to the membrane itself by way of the dissociated hydrogen transport mechanism. In this manner hydrogen is effectively physically removed from the feed gas, and the initial hydrogen partial pressure of the feed gas is progressively lowered as more and more hydrogen is given up to the membrane. Thus, the partial pressure of hydrogen in the feed gas, as it sweeps along the source side of the membrane from the inlet end to the outlet end, is progressively reduced while the partial pressure of hydrogen is progressively built up on the permeate side.

Although this description is, for sake of clarity, made in respect of a single membrane structure, this invention also applies to a structure composed of a plurality of membranes. All such structures, single and any combination of a plurality thereof, are within the scope of this invention.

Hydrogen embrittlement of a host metal that is exposed to hydrogen gas is known, and generally involves an interaction of hydrogen with the host metal which results in the host becoming more brittle physically and less malleable, that is to say the yield strength of the host increases toward its ultimate strength. This is not a desirable result for a membrane because even micro-cracks in a membrane can lead to undesired hydrogen and other gas leaks, as opposed to only dissociated hydrogen transport through the membrane.

As has been known for most of the twentieth century, a hydrogen extraction membrane can be composed solely of nonporous palladium. It has also been known for some time that, in order to reduce the expense of such a membrane, a composite structure can be employed. Such a composite is composed largely of a less expensive base metal that will transport dissociated hydrogen. The composite's base metal source side, sink side, or both are coated with a noble metal catalyst for assisting in the dissociation, re-association, and desorption of hydrogen. Such metals include palladium. The base metal core of such a composite membrane is coextensive with the surface area sides (source and sink) of the membrane. The coating or coatings of palladium on the base metal structure is usually coextensive with the base metal structure. The thickness of such a coating or coatings on each side (source or sink) of the membrane will generally be from about 200 to about 1,000 nanometers.

The palladium layers employed on the vanadium/nickel core (base) of this invention are deposited, pursuant to this invention, on the core by a combination of sputter etching and vacuum deposition. Both processes are known in the art.

Generally, sputter etching of the core is carried out by bombardment with argon ions down to 10⁻⁴ atmospheres using a 13.56 megahertz RF frequency generator operating at 30 watts.

Vacuum deposition of the palladium layers on the etched core is carried out by heating the palladium to approximately 1600° C. in an alumina coated tungsten boat.

Hereafter, in the interest of clarity, the membrane will be discussed as a composite of a vanadium base metal coated with palladium on both its source and sink sides co-extensively with the base metal structure, but the scope of this invention is not so limited. The palladium coating functions as a dissociation and re-association catalyst, and, at the same time, serves to protect the underlying vanadium from reaction with components in the feed gas other than hydrogen, e.g., steam. Such membranes are capable of extracting hydrogen from high pressure industrial gas mixtures having pressures of, for example, from about 250 to about 500 psia while sustaining a substantial pressure drop across the membrane, e.g., from about 349 to about 499 psia. These membranes can also operate at elevated temperatures, e.g., from about 300 to about 440° C. As such, these membranes are well suited for processing WGS product gases.

The membranes modified pursuant to this invention can be altered chemically for increased embrittlement protection by incorporating nickel into the base metal by physical mixture or alloying. The membranes of this invention can contain up to about 10 atom % nickel based on the total membrane. Nickel can be incorporated into the vanadium base in amounts less than about 1.00 atom % based on the total of vanadium and nickel. Thus, nickel can be present in the membrane of this invention in a finite amount, but less than 1.00 atom % based on the total of vanadium and nickel.

The core of the membranes of this invention can be made in any conventional manner such as melting and mixing the base and any additive nickel, compressing and sintering mixtures of particles of such metals, solid state diffusion, and the like, all of which are well known in the art, and further detail is not necessary to inform the art.

Sweep gas such as inert gases (argon and the like), nitrogen, steam, and mixtures thereof can be employed on the permeate side promptly to remove hydrogen from that side and thereby enhance the hydrogen separation efficiency. In general, the sweep gas is used in a sufficient amount to maintain the hydrogen partial pressure on the permeate side of the membrane in a range of about 0.02 to about 2 psia.

Guard beds such as a combination of copper and zinc oxide and the like can be employed to remove impurities such as hydrogen sulfide from the WGS product before contacting same with the membranes of this invention.

### Specific Embodiments of the Invention

### EXAMPLE

A planar membrane about ⅞ inches in diameter was formed by the process of arc melting and cold rolling. The body of the membrane was composed principally of vanadium and contained 0.1 atom % nickel based on the total of vanadium and nickel in the membrane.

Palladium was deposited on both the source and permeate sides of this membrane by vacuum evaporation. The resulting membrane was about 130 microns thick.

This membrane was exposed to a simulated incoming water-gas-shift product gas composed of about 37.3 mole percent (mol. %) steam, about 17.8 mol. % carbon dioxide, about 41.4 mol. % molecular hydrogen, and about 3.3 mol. % CO, with the balance essentially nitrogen with trace impurities. This feed gas was at a temperature of about 429 C, and a pressure of about 451 psia.

A pressure drop of about 450 psia across the membrane from the hydrogen source (feed) side to the sink (permeate) side was established and maintained. The hydrogen partial pressure at the permeate side was maintained at about 1.00 psia.

Argon at a flow rate of about 5 liters/minute at STP was employed as a sweep gas promptly to remove hydrogen from the permeate side.

The dissociated hydrogen flux rate through the membrane was about 180 mL min⁻¹cm⁻². It was observed that Sieverts' law was closely followed, indicating that hydrogen was dissociated before transport through the membrane.

Under the above conditions, the foregoing membrane produced an essentially pure hydrogen permeate, and a carbon dioxide enriched retentate at about 500 psia. After 24 hours of operation the membrane was visually examined and found to be slightly deformed due to the 450 psia differential pressure, but did not rupture or leak. Upon examination of the membrane using energy dispersive x-ray spectroscopy no gross impurities were identified on either side of the membrane.

What is claimed is:

1. In a method for separating molecular hydrogen from a high pressure gaseous mixture containing at least carbon dioxide and said hydrogen, and using a dense vanadium based membrane that has a hydrogen source side and a hydrogen permeate side, the improvement comprising providing a vanadium membrane containing from zero up to about 10 atomic percent of nickel based on the total membrane, said membrane having a palladium coating on at least said source side, said membrane having a thickness of from about 75 to about 500 microns, exposing said membrane to said gaseous mixture at a temperature of from about 300 to about 440° C. and a source side pressure of from about 250 to about 500 psia, maintaining a hydrogen partial pressure gradient across said membrane from said source side to said permeate side which provides a hydrogen partial pressure on said permeate side of from about 0.02 to about 2 psia, and removing molecular hydrogen from said permeate side, whereby a high hydrogen flux rate is maintained through said membrane

2. The method of claim 1 wherein said gaseous mixture is a product of at least one water-gas-shift reaction.

3. The method of claim 1 wherein said gaseous mixture is comprised of a major amount of a mixture of steam, carbon dioxide, carbon monoxide, and molecular hydrogen, with the remainder being essentially nitrogen, hydrogen sulfide, and ammonia.

4. The method of claim 3 wherein said gaseous mixture contains at least about 50 mole percent of a mixture of molecular hydrogen and carbon dioxide based on the total moles in said mixture, and the molar ratio of hydrogen to carbon dioxide is about 2/1.

5. The method of claim 1 wherein said membrane contains from about 0 to about 10 mole percent nickel based on the total moles in said membrane.

6. The method of claim 1 wherein said membrane thickness is about 130 microns.

7. The method of claim 1 wherein said molecular hydrogen on said permeate side of said membrane is continually removed from said permeate side.

8. The method of claim 1 wherein said membrane has a palladium coating on both said source side and said permeate side.

9. The method of claim 1 wherein said palladium is deposited on said vanadium membrane by sputter etching followed by vacuum deposition of said palladium on to said vanadium.

10. The method of claim 1 wherein said membrane contains a finite amount of nickel but less than 1.00 atomic percent nickel based on the total membrane.
